(19) United States
(12) Patent Application Publication
(10) Pub. No.: US 2026/0259940 A1
(43) Pub. Date: Sep. 3, 2026

(54) EXTRACTING INFORMATION FROM VISUALIZATIONS IN DOCUMENTS

(71) Applicant: S&P Global Inc., New York, NY (US)

(72) Inventors: J Brandon Smock, Seattle, WA (US); Maury Alex Courtland, Durham, NC (US); Valerie Karen Faucon-Morin, New York, NY (US); Libin Liang, Piscataway, NJ (US); Ansh Khandelwal, Pittsburgh, PA (US); Maxim Sokolov, Watertown, MA (US)

(21) Appl. No.: 19/067,065

(22) Filed: Feb. 28, 2025

(51) Int. Cl. G06F 16/93; G06F 16/906

(52) U.S. Cl. CPC G06F 16/93; G06F 16/906

(57) ABSTRACT

An illustrative embodiment provides a computer-implemented method. The method comprises using a processor set to receive a number of documents; to identify a number of objects within the number of documents and locations for the number of objects from the number of documents; to identify the number of visualizations from the number of objects within the number of documents; to classify the number of visualizations into different visualization types; to parse the number of visualizations to generate a number of graphs representing the number of visualizations based on visualization types for the number of visualizations; to extract textual information associated with the number of visualizations from pages that comprise the number of visualizations in the number of documents; and to generate the machine readable table for the number of visualizations based on the number of graphs and the textual information associated with the number of visualizations.

### BACKGROUND INFORMATION

### 1. Field

The present disclosure relates generally to extracting information from visualizations in documents.

### 2. Background

Information extraction is the process of identifying and retrieving relevant details from a document. It involves converting unstructured data into structured data such that retrieved data can be easily analyzed and used. This process is widely used in areas such as search engines, data analytics, and automated summarization.

The extraction process typically includes identifying key elements like names, dates, locations, numbers, or relationships between different pieces of information. In this case, automation through Natural Language Processing (NLP) and machine learning can be used to handle large volumes of data efficiently even though process can be done manually.

### SUMMARY

An illustrative embodiment provides a computer-implemented method for converting visualizations in documents to a machine readable table. The method comprises using a processor set to receive a number of documents, where the number of documents comprise a number of visualizations. The processor set identifies a number of objects within the number of documents and locations for the number of objects from the number of documents using a set of machine learning models. The processor set identifies the number of visualizations from the number of objects within the number of documents using the set of machine learning models. The processor set classifies the number of visualizations into different visualization types, where each visualization from the number of visualizations is labeled with zero or more visualization types. The processor set parses the number of visualizations to generate a number of graphs representing the number of visualizations based on visualization types for the number of visualizations using the set of machine learning models. The processor set extracts textual information associated with the number of visualizations from pages that comprise the number of visualizations in the number of documents. The processor set generates the machine readable table for the number of visualizations based on the number of graphs and the textual information associated with the number of visualizations.

Another illustrative embodiment provides a computer system for converting visualizations in documents to a machine readable table. The system comprises a processor set, a set of one or more computer-readable storage media, and program instructions stored on the set of one or more storage media to cause the processor set to perform operations comprising receiving a number of documents, where the number of documents comprise a number of visualizations; identifying a number of objects within the number of documents and locations for the number of objects from the number of documents using a set of machine learning models; identifying the number of visualizations from the number of objects within the number of documents using the set of machine learning models; classifying the number of visualizations into different visualization types, where each visualization from the number of visualizations is labeled with zero or more visualization types; parsing the number of visualizations to generate a number of graphs representing the number of visualizations based on visualization types for the number of visualizations using the set of machine learning models; extracting textual information associated with the number of visualizations from pages that comprise the number of visualizations in the number of documents; and generating the machine readable table for the number of visualizations based on the number of graphs and the textual information associated with the number of visualizations.

Another illustrative embodiment provides a computer program product for converting visualizations in documents to a machine readable table. The computer program product comprises a set of one or more computer-readable storage media, and program instructions stored in the set of one or more storage media to perform operations comprising using a processor set to receive a number of documents, where the number of documents comprise a number of visualizations; to identify a number of objects within the number of documents and locations for the number of objects from the number of documents using a set of machine learning models; to identify the number of visualizations from the number of objects within the number of documents using the set of machine learning models; to classify the number of visualizations into different visualization types, where each visualization from the number of visualizations is labeled with zero or more visualization types; to parse the number of visualizations to generate a number of graphs representing the number of visualizations based on visualization types for the number of visualizations using the set of machine learning models; to extract textual information associated with the number of visualizations from pages that comprise the number of visualizations in the number of documents; and to generate the machine readable table for the number of visualizations based on the number of graphs and the textual information associated with the number of visualizations.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 depicts a block diagram of a data management environment in accordance with an illustrative embodiment;

FIGS. 3A-3B depict exemplary labeling of objects on a page for a document in accordance with an illustrative embodiment;

FIG. 4 depicts exemplary labeling of elements on visualizations in accordance with an illustrative embodiment;

FIG. 5 depicts exemplary architecture for extracting information associated with elements in visualizations in accordance with an illustrative embodiment;

FIG. 6 depicts a flowchart illustrating a process for converting visualizations in documents to a machine readable table in accordance with an illustrative embodiment;

FIG. 7 depicts a flowchart illustrating a process for generating vectors to represent relationships and dependencies between elements in a visualization in accordance with an illustrative embodiment;

FIG. 8 depicts a flowchart illustrating a process for outputting an adjacency matrix in accordance with an illustrative embodiment;

FIG. 9 depicts a flowchart illustrating a process for outputting an adjacency matrix in accordance with an illustrative embodiment;

FIG. 10 depicts a flowchart illustrating a process for outputting an adjacency matrix in accordance with an illustrative embodiment;

FIG. 11 depicts a flowchart illustrating a process for predicting shape of elements in a visualization in accordance with an illustrative embodiment;

FIG. 12 depicts a flowchart illustrating a process for predicting color of elements in a visualization in accordance with an illustrative embodiment;

FIG. 13 depicts a flowchart illustrating a process for predicting categories of elements in a visualization in accordance with an illustrative embodiment; and

FIG. 14 is a block diagram of a data processing system in accordance with an illustrative embodiment.

### DETAILED DESCRIPTION

The illustrative embodiments recognize and take into account a number of considerations. For example, the illustrative embodiments recognize and take into account that currently a very large amount of data is contained in visualizations inside unstructured documents such as PDF and PowerPoint. The illustrative embodiments recognize and take into account that data in the form described above is not directly machine readable, which prevents many potential uses of the data.

The illustrative embodiments recognize and take into account that extracting information from visualizations such as charts, graphs, diagrams, and tables, presents several challenges due to their visual nature and structural complexity. The illustrative embodiments recognize and take into account that unlike plain text, visualizations require a combination of image processing, pattern recognition, and contextual understanding to extract meaningful data.

The illustrative embodiments also recognize and take into account that visualizations come in many different forms and each form has a unique structure and requires specialized techniques for extraction. For example, a method that works for tables may not be effective for a heatmap or a complex network diagram.

Thus, illustrative embodiments of the present invention provide a computer implemented method, computer system, and computer program product for converting visualizations in documents to a machine readable table. The method comprises using a processor set to receive a number of documents, where the number of documents comprise a number of visualizations. The processor set identifies a number of objects within the number of documents and locations for the number of objects from the number of documents using a set of machine learning models. The processor set identifies the number of visualizations from the number of objects within the number of documents using the set of machine learning models. The processor set classifies the number of visualizations into different visualization types, where each visualization from the number of visualizations is labeled with zero or more visualization types. The processor set parses the number of visualizations to generate a number of graphs representing the number of visualizations based on visualization types for the number of visualizations using the set of machine learning models. The processor set extracts textual information associated with the number of visualizations from pages that comprise the number of visualizations in the number of documents. The processor set generates the machine readable table for the number of visualizations based on the number of graphs and the textual information associated with the number of visualizations.

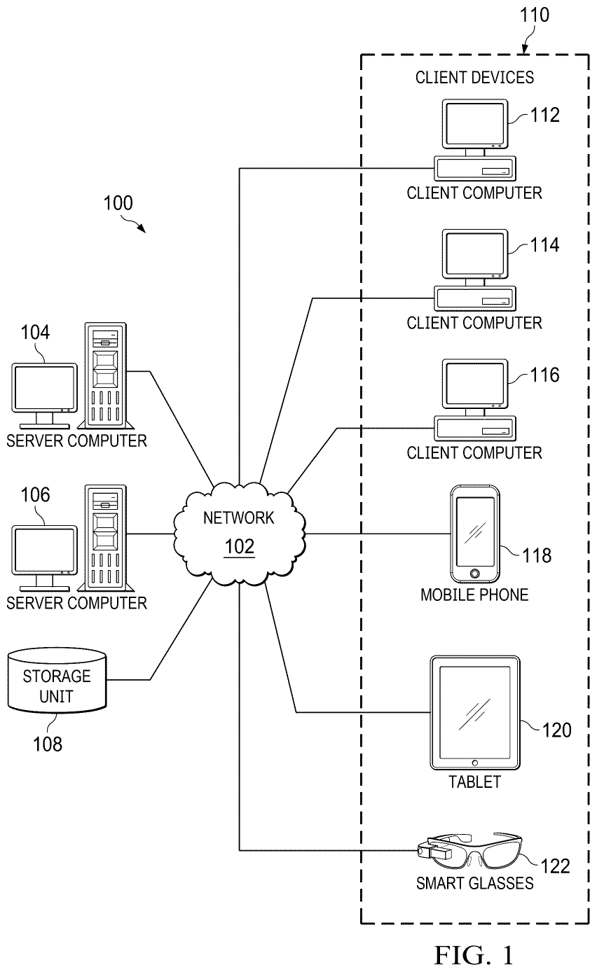

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

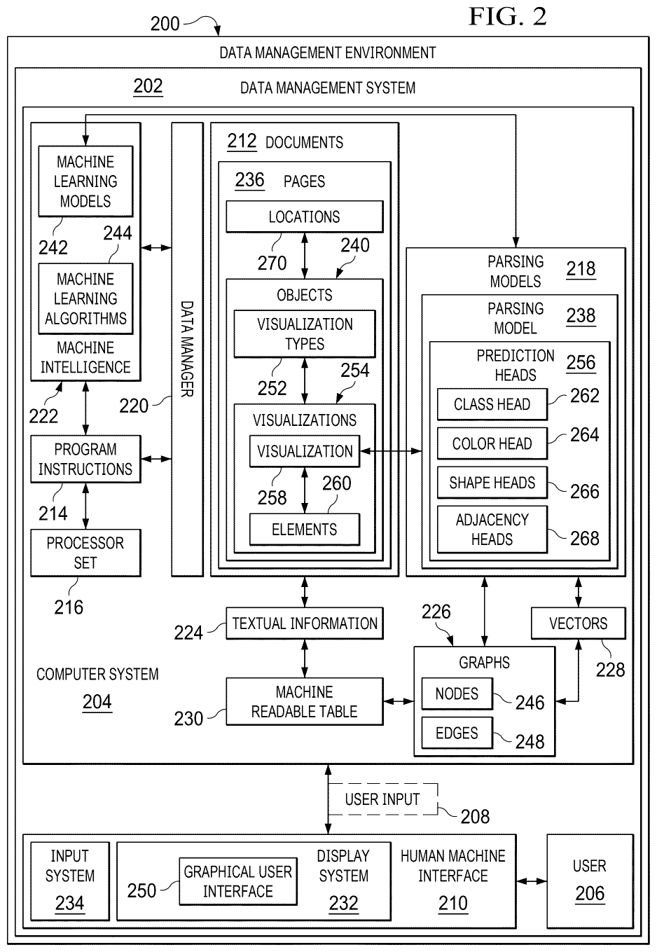

With reference now to FIG. 2, an illustration of a block diagram of a data management environment is depicted in accordance with an illustrative embodiment. In this illustrative example, data management environment 200 includes components that can be implemented in hardware such as the hardware shown in network data processing system 100 in FIG. 1.

In this illustrative example, data management system 202 in data management environment 200 enables extraction of textual information 224 from a number of documents 212 and creation for graphs 226 for generating machine readable table 230 such that visualizations in the number of documents 212 can be efficiently processed by computer system 204. In this illustrative example, data management system 202 includes computer system 204 which includes data manager 220. Data manager 220 is located in computer system 204.

Data manager 220 can be implemented in software, hardware, firmware, or a combination thereof. When software is used, the operations performed by data manager 220 can be implemented in program instructions configured to run on hardware, such as a processor unit. When firmware is used, the operations performed by data manager 220 can be implemented in program instructions and data and stored in persistent memory to run on a processor unit. When hardware is employed, the hardware can include circuits that operate to perform the operations in data manager 220.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 216 in FIG. 2. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 222. Machine intelligence 222 can include a set of machine learning models 242 and machine learning algorithms 244. Machine learning models 242 is a branch of artificial intelligence (AI) that enables computers to detect patterns and improve performance without direct programming commands. Rather than relying on direct input commands to complete a task, the set of machine learning models 242 relies on input data. The data is fed into the machine, one of machine learning algorithms 244 is selected, parameters for the data are configured, and the machine is instructed to find patterns in the input data through optimization algorithms. The data model formed from analyzing the data is then used to predict future values.

Machine intelligence 222 is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching machine intelligence 222.

Machine intelligence 222 can be implemented using one or more systems such as an artificial intelligence system, a neural network, a generative neural network, a Bayesian network, an expert system, a fuzzy logic system, a genetic algorithm, or other suitable types of systems. The set of machine learning models 242 and machine learning algorithms 244 may make computer system 204 a special purpose computer for extracting information from a number of visualizations 254 from the number of documents 212 and converting the extracted information into machine readable table 230.

As depicted, the set of machine learning models 242 involves using machine learning algorithms 244 to build computation models based on samples of data. The samples of data used for training are referred to as training data or training datasets. Machine intelligence 222 can make predictions without being explicitly programmed to make these predictions. Machine intelligence 222 can be used for training and retraining computation models for a number of different types of applications. These applications include, for example, medicine, financial services, healthcare, speech recognition, computer vision, or other types of applications.

In this illustrative example, the set of machine learning models 242 can include a number of models. For example, models in the set of machine learning models 242 can include a number of parsing models 218 for processing pages 236 and the number of visualizations 254 in the number of documents 212. In this illustrative example, the number of parsing models 218 are a type of model designed to analyze and extract structured information from unstructured or semi-structured data.

In another example, the set of machine learning models 242 can include a deep learning model such as a large language model. In this illustrative example, a large language model is a type of machine learning model designed to understand, generate, and manipulate human language.

In this illustrative example, machine learning algorithms 244 can include supervised machine learning algorithms, semi-supervised machine learning algorithms, reinforcement learning algorithms, and unsupervised machine learning algorithms. In this illustrative example, above mentioned machine learning algorithms can train machine learning models using data containing both the inputs and desired outputs. Examples of machine learning algorithms include algorithms for neural networks, XGBoost, K-means clustering, and random forest.

As depicted, data manager 220 extracts information from the number of visualizations 254 in the number of documents 212 to create machine readable table 230. In this illustrative example, machine readable table 230 is a structured format of data that can be easily processed by computer system 204. Unlike tables designed for human readability, machine readable table 230 uses standardized formats that allow software to efficiently read, analyze, and manipulate data.

In this illustrative example, data manager 220 receives the number of documents 212 from a number of data sources. The number of documents 212 contain a number of pages 236 and the number of pages 236 include a number of objects 240. In this example, the number of objects 240 are components that make up the content and structure for the number of pages 236. The number of objects 240 can be categorized based on their functions and representations. For example, the number of objects 240 can include paragraphs, headings, titles, images or graphics such as the number of visualizations 254, headers, footers, page numbers, or any suitable objects that can be found a page of document.

In this illustrative example, data manager 220 identifies the number of objects 240 from the number of pages 236 and locations 270 for the number of objects 240. Locations 270 are positions for the number of objects 240 from the number of documents 212. In illustrative example, locations 270 and the number of objects 240 can be identified by performing document layout analysis (DLA) for every page from the number of pages 236.

In this example, document layout analysis (DLA) can be implemented using the set of machine learning models 242 and parsing models 218. For example, a machine learning model from the set of machine learning models 242 or a parsing model from parsing models 218 can be specifically trained for detecting objects 240 within documents 212. In this illustrative example, the model for detecting objects 240 within documents 212 can be a model that uses images as input.

In this illustrative example, data manager 220 identifies the number of visualizations 254 from objects 240 based on the document layout analysis (DLA) described above. In this example, each visualization detected by the DLA model has a context associated with it. The context is potentially any content from page from pages 236 where the visualization was detected in.

In other words, the DLA model identifies particular relevant context for a visualization such as visualization 258 from the number of visualizations 254 and other elements connected to visualization 258 with edges to represent relationships. This includes titles, captions, and potentially other visualizations if they share any content relevant to visualization 258.

In this illustrative example, the number of visualizations 254 include elements 260 within the number of visualizations 254. Elements 260 are components that make up a visualization from visualizations 254. For example, elements 260 can include title, axes, data points, legends, labels and annotations, patterns, or any suitable component that can be found in the number of visualizations 254.

In this illustrative example, data manager 220 uses the set of machine learning models 242 to classify each visualization from the number of visualizations 254 into zero or more visualization types from visualization types 252. In this example, visualization types 252 can include a bar chart, line plot, pie chart, histogram, scatter plot, flow chart, map, heatmap, radar plot, or any suitable type of visualization in documents.

In this illustrative example, data manager 220 uses the set of machine learning models 242 to output any visualization type for which elements associated with that visualization type are present in each visualization from the number of visualizations 254. For example, visualization 258 from the number of visualizations 254 may contain both bars associated with a bar chart, and lines associated with a line plot. In this example, data manager 220 can output both labels “bar chart” and “line plot” for visualization 258. It should be noted that it is also possible that no label is output at all. In this example, the lack of output label indicates that the visualization is of a type of unknown to data manager 220 and set of machine learning models 242.

In this illustrative example, the aforementioned visualization classification is considered a multi-label image classification problem in machine learning. In this example, many standard model architectures can be used to implement this classification task. For example, the classification task can be implemented using ResNet-50 or its variants, VGG-16 or its variants, ViT or its variants.

In this illustrative example, data manager 220 further parses the number of visualizations 254 based on visualization types 252 and context extracted for the number of visualizations 254 as mentioned above. In this example, data manager 220 can parse the number of visualizations 254 using the number of parsing models 218.

In this illustrative example, each parsing model from the number of parsing models 218 is a specialized parsing model designated to a visualization type from the number of visualizations 254. For example, parsing model 238 can be a parsing model for a visualization type of visualization 258. In this illustrative example, the number of parsing models 218 can detect elements such as bars, bar labels, legend markers, legend entries, ticks, tick labels, titles, X labels, y labels, or any suitable element on visualizations 254. In the illustrative example, parsing models 218 output vectors 228 to represent elements 260 for the number of visualizations 254 and relationship and dependencies between elements 260.

In addition, the number of parsing models 218 can also predict edges representing associations between different elements such as those between particular bars and particular legend entries, bars and tick labels, bars and bar labels, ticks and tick labels, or any suitable relationships.

As depicted, parsing model 238 can be a parsing model for a visualization type of visualization 258. In this illustrative example, parsing model 238 can identify a number of elements from elements 260 and input the identified elements into a self-attention layer in parsing model 238 to identify relationships and dependencies between the identified elements for visualization 258. In this illustrative example, output from the self-attention layer can be passed into a number of adjacency heads 268 in prediction heads 256 for generating an adjacency matrix for identified elements for visualization 258.

In this illustrative example, prediction heads 256 include software modules that are specifically designed to make predictions for a specific task. For example, the number of adjacency heads 268 can be configured for predicting relationships and dependencies between identified elements for visualization 258. In this example, the number of adjacency heads are standard multi-layer perceptrons (MLP) for generating outputs for each input, wherein outputs generated for each input correspond to one full row of the adjacency matrix.

In this illustrative example, the number of adjacency heads 268 can be implemented in a number of ways. For example, the number of adjacency heads 268 can operate directly on the output of the self-attention layer.

In another example, the number of adjacency heads 268 can operate on a processed version of the output of the self-attention layer. Following the self-attention layer, data manager 220 creates all possible pairs of outputs from the self-attention layer and concatenates each pair together. In other words, data manager 220 creates a number of vector pairs from the number of vectors 228 that represent identified elements for visualization 258. Subsequently, the number of adjacency heads 268 operate on each of these concatenated pairs to generate the adjacency matrix for visualization 258.

In yet another example, the number of adjacency heads 268 can operate on a processed version of the output of the self-attention layer. Following the self-attention layer, data manager 220 creates all possible pairs of outputs from the self-attention layer and sums each pair together. In other words, data manager 220 creates a number of vector pairs from the number of vectors 228 that represent identified elements for visualization 258. Subsequently, the number of adjacency heads 268 operate on each of these summed pairs to generate the adjacency matrix for visualization 258.

In addition, prediction heads 256 can further include a number of shape heads 266, class head 262, and color head 264. In this illustrative example, class head 262 can be used for predicting an element category of each element from the identified elements for the visualization 258. For example, element category can include title, axes, data points, legends, labels and annotations, patterns, or any suitable element category.

In this illustrative example, each element from the identified elements for visualization 258 can be input into each shape from the number of shape heads 266. In this example, each shape has its own head that predicts the coordinates of that shape for each element from the identified elements for visualization 258. In this illustrative example, the number of shape heads 266 can include shape heads for a 2D point, a bounding box, a quadrilateral, a polygon with N points, or a discrete curve.

In this example, bounding box shape heads from the number of shape heads 266 predict coordinates for elements with the shape of bounding boxes. In a similar fashion, curve shape head from the number of shape heads 266 predicts coordinates for curved elements. In this illustrative example, each shape is defined by a fixed number of coordinates for that shape.

In this illustrative example, each shape head from the number of shape heads 266 is trained with a loss or losses specific to that shape. For example, the bounding box head can use GIoU and L1 loss and the curve head can use L1 loss over the coordinates, plus L1 loss over the difference of neighbouring coordinates. During model training, the loss for shapes can be masked to improve accuracy and efficiency for the number of shape heads 266. For example, for a curve element, curve shape can be defined and the loss for other shapes can be masked (zero out).

It should be noted that multiple shapes can be predicted for the same element using the number of shape heads 266. For example, for a curve element, a curve shape and a bounding box shape can be provided but the loss for the rest of the shape heads can be masked. In other words, the identified elements for visualization 258 can be passed through multiple shape heads from the number of shape heads 266 such that shapes for the identified elements for visualization 258 can be accurately predicted.

In addition, color head 264 predicts the color values of the input image at the elements' bounding box location, cropped, and resized to be M×M pixels, where M can be any positive integer defined by a user such as user 206. In this illustrative example, an input image with a collection of elements can be overlayed with each elements' M×M low-resolution color grid on top at the same location. For each element from the identified elements for visualization 258, color head 264 is tasked with predicting this low-res image of M×M pixel values.

In this example, color head 264 is useful as a complementary auxiliary task to graph prediction. In other words, the prediction made by this head is not essential at inference time to produce a graph. But during training it provides a very useful, complementary signal that improves the model's ability to learn to solve the other tasks.

As parsing models 218 generates vectors 228 for the number of visualizations 254 to represent information of elements 260 contained within the number of visualizations 254. In other words, all outputs from different heads in prediction heads 256 can be presented in the form of numerical vectors for further processing.

In this illustrative example, data manager 220 uses vectors 228 and other information for the number of visualizations 254 to create a number of graphs 226. Each graph from the number of graphs 226 represents a visualization from the number of visualizations 254.

Further, the number of graphs 226 further contain nodes 246 and edges 248 between nodes 246. In this illustrative example, each node from nodes 246 represent an element from the number of visualizations 254 and edges 248 represent relationships between elements from the number of visualizations 254.

In addition, data manager 220 extracts textual information 224 from pages that contain the number of visualizations 254. In this illustrative example, textual information 224 is represented as words or tokens with their bounding box locations, from a page or pages containing the number of visualizations 254.

In this example, the text for native or digital-born documents can be extracted directly from the file using various software packages, such as PyMuPDF. In the case of scanned documents, or in the case of rasterized images embedded in digital documents, an optical character recognition (OCR) method can be run to extract some or all of the text. In this illustrative example, the text extraction can optionally always use OCR, or data manager 220 can compare the output of native text extraction and DLA to determine if any OCR methods need to be run.

In this illustrative example, data manager 220 generates machine readable table 230 based on textual information 224 and the number of graphs 226. In this example, machine readable table 230 can be generated in a number of ways. For example, data manager 220 can merge elements detected with textual information 224 using the number of parsing models 218. In other words, for each text-related element such as title and bar label inferred by the number of parsing models 218, data manager 220 matches that element with overlapping text elements. Any text element overlapping with an element from the number of visualizations 254 is associated with that element. For example, a bar label detected by the number of parsing models 218 may overlap with a text element containing the text “33”. These two are associated together, so that the bar label reads “33”.

Subsequently, data manager 220 creates a mapping from pixel values to data values for each axis of data contained within a visualization from the number of visualizations 254. In the case where only the y-axis of data can be identified, data manager 220 creates a mapping from y-values in pixel space to data values in the y-direction. Plot data elements such as vertical bars, and line plots, which are located in pixel coordinates identified by the number of parsing models 218, are then mapped from their pixel values to their data values in each data axis.

Further, the column and row headers of machine readable table 230 are determined. Column headers are usually listed in the visualizations as legend entries. On the other hand, row headers can be listed in the visualizations as x tick labels, y tick labels, another entity, or not at all. These headers can also be inferred from the data values themselves if the headers are not labeled explicitly in the visualizations or in their surrounding context.

Finally, the data values are collected into machine readable table 230, where each data value is placed into the row and column of the column header or row header it is associated with. These associations can be identified in outputs generated by the number of parsing models 218.

In this illustrative example, users such as user 206 can interact with computer system 204 through user inputs to computer system 204. For example, computer system 204 can receive user input 208 that includes definition of M for color head 264.

In this illustrative example, user input 208 can be generated by user 206 using human machine interface (HMI) 210. As depicted, human machine interface 210 includes display system 232 and input system 234. Display system 232 is a physical hardware system and includes one or more display devices on which graphical user interface 250 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 250 through user input 208 generated by input system 234. Input system 234 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, user 206 can view documents 212, pages 236, objects 240, visualizations 254, graphs 226, and machine readable table 230 through graphical user interface 250 in display system 232. In addition, user 206 can provide user input 208 through graphical user interface 250.

In one illustrative example, one or more solutions are present that overcome a problem with extracting information from in documents. Especially for extracting quantitative information from visualizations in documents. As a result, one or more technical solutions may provide an ability to increase efficiency and resources utilization for processing quantitative data from visualizations of documents in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which data manager 220 in computer system 204 enables extraction of quantitative data from visualizations of documents. In particular, data manager 220 transforms computer system 204 into a special purpose computer system as compared to currently available general computer systems that do not have data manager 220.

In the illustrative example, the use of data manager 220 in computer system 204 integrates processes into a practical application for extraction of quantitative data from visualizations of documents. Data manager 220 improves efficiency of data processing for visualizations such that performance of computer system 204 can be increased. In other words, data manager 220 in computer system 204 is directed to a practical application of processes integrated into data manager 220 in computer system 204 that enables processing of quantitative data in visualizations of documents in an efficient manner.

The illustration of data management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, extraction of textual information 224 and parsing for the number of visualizations 254 using the number of parsing models 218 can be performed in parallel.

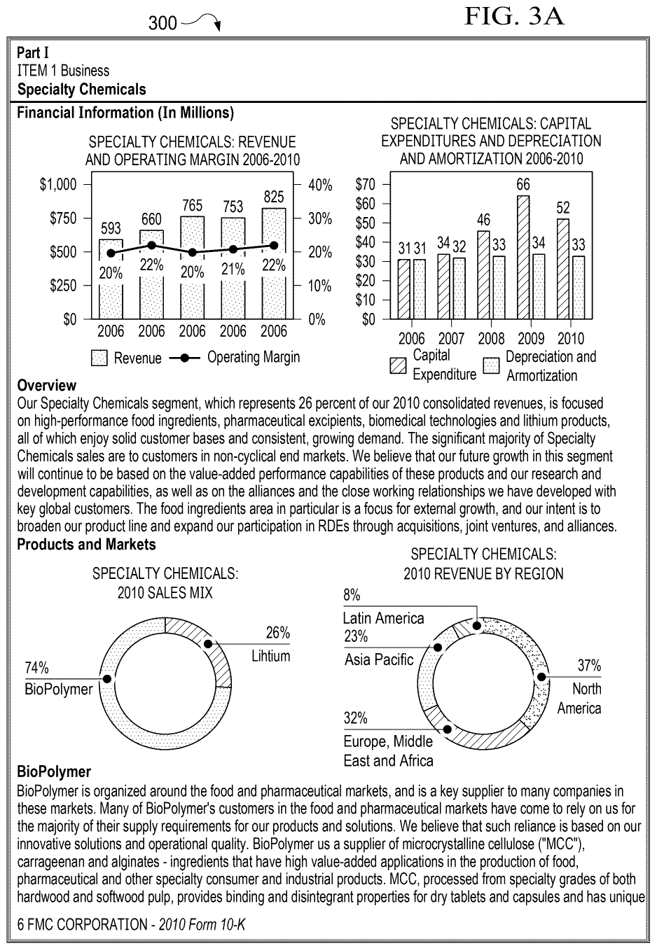

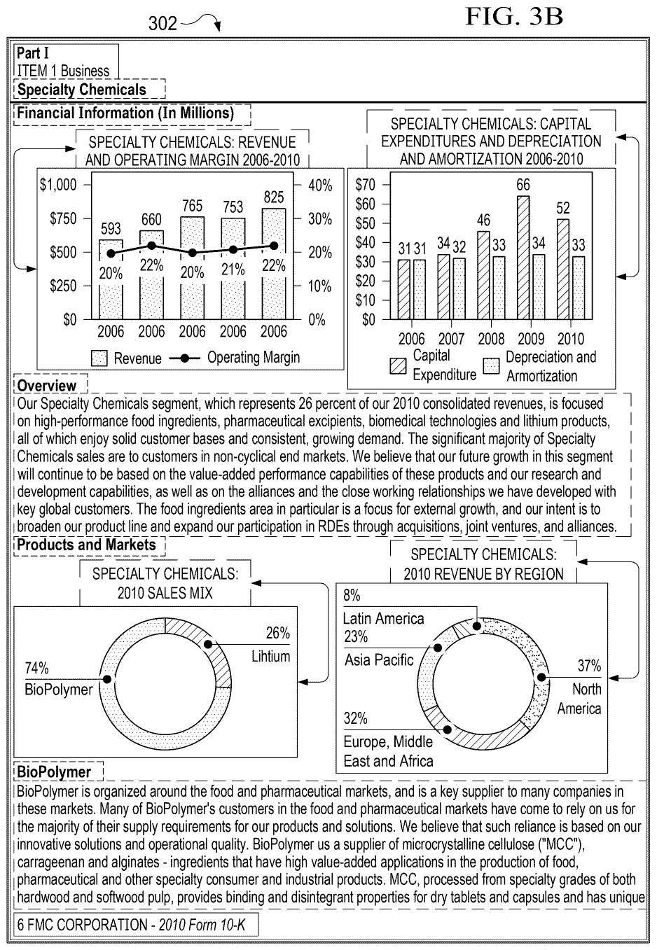

FIG. 3A-3B depict an exemplary labeling of objects on a page for a document in accordance with an illustrative embodiment. In this illustrative example, page 300 and page 302 can be examples of pages in documents 212 in FIG. 2. In addition, page 300 can be an example of input for document layout analysis (DLA) and page 302 can be an example of output for document layout analysis (DLA) as described in FIG. 2. In this illustrative example, identification and labelling of objects on page 300 can be implemented using data manager 220 and computer system 204 in FIG. 2.

In this illustrative example, page 300 shows a variety of objects. For example, page 300 contains title, headers, and a number of visualizations with descriptions for the number of visualizations. As depicted, objects on page 300 can be identified and labelled as illustrated in page 302 using data manager 220 in FIG. 2.

In page 302, objects are labelled with bounding boxes and relationships between different objects are depicted with arrows. In this illustrative example, the bounding boxes that surround objects on page 302 can be illustrated in different colors. For example, bounding boxes for histograms and pie charts can be illustrated in same color while bounding boxes for titles such as “Specialty Chemicals”, “Financial Information (In Millions)”, “Overview”, “Products and Markets”, and “BioPolymer” can be illustrated same color.

In a similar fashion, bounding boxes for descriptions of visualizations in page 302 can be illustrated in same color while bounding boxes for title of visualizations can be illustrated in same color.

The illustration of page 300 and page 302 in FIG. 3 are not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, edges or arrows between objects shown in page 300 and page 302 can also be illustrated using different colors.

FIG. 4 depicts an exemplary labeling of elements on visualizations in accordance with an illustrative embodiment. In this illustrative example, visualization 400, visualization 402, and visualization 404 can be examples of the number of visualizations 254 in FIG. 2. In this illustrative example, visualization 402 and visualization 404 can be examples of outputs generated by the number of parsing models 218.

In this illustrative example, visualization 400, visualization 402, and visualization 404 show histograms that present amounts of “Capital Expenditure” and “Depreciation and Amortization” over a period of time from 2006 to 2010. As depicted, elements in visualization 400 can be identified and labeled, as illustrated in visualization 402 and visualization 404.

For example, elements such as legend, axis label, and bars can be identified and labelled using data manager 220 in FIG. 2. In addition, visualization 402 also shows edges between legends and bars to indicate that left bars in histogram are used to show amounts for “Capital Expenditure” while right bars in histogram are used to show amounts for “Depreciation and Amortization”.

In a similar fashion, visualization 404 shows edges between bars and axis labels to indicate that bars with amounts on histogram belong to categories of different years range from 2006 to 2010.

In this illustrative example, the extraction and labelling of elements shown in visualization 400, visualization 402, and visualization 404 helps to understand the relationships between different elements, thereby providing more comprehensive information for visualization 400, visualization 402, and visualization 404.

The illustration of visualization 400, visualization 402, and visualization 404 in FIG. 4 are not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, the extraction and labelling of elements can also be performed to other type of visualizations.

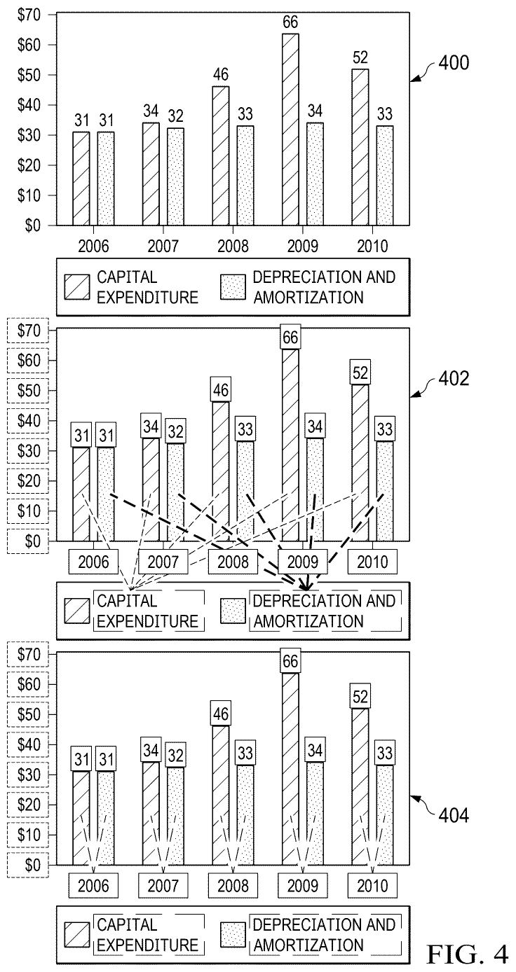

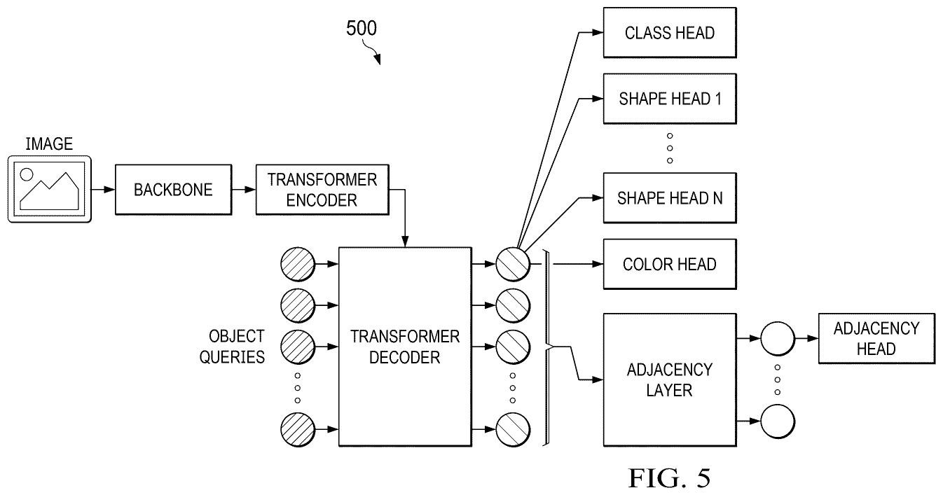

FIG. 5 depicts an exemplary architecture for extracting information associated with elements in visualizations in accordance with an illustrative embodiment. In this illustrative example, architecture 500 can be implemented using data manager 220 and different components from computer system 204 in FIG. 2.

In this illustrative example, visualizations such as images can be used as input to architecture 500. In architecture 500, a backbone network is configured to extract features of elements contained in the input image. In this example, the backbone network can be a convolutional neural network, and the extracted features can be used to generate a high-level feature map for elements contained in the input image.

The extracted features are then fed into a transformer encoder that restructures the extracted features into a format suitable for self-attention mechanisms. The restructuring of extracted features can involve flattening the feature map into a sequence of tokens representing elements in the input images. In this example, the transformer encoder can include multiple layers of self-attention and feedforward networks, which enable architecture 500 to capture dependencies and global contextual relationships across the input image. The output of the transformer encoder is a set of object queries that provide a deep understanding of elements and can be used for determining embeddings for the elements on the input images.

Next, the set of object queries are passed into a transformer decoder, which generates embeddings for discovering elements on the input image. In this illustrative example, embeddings for the elements on the input image can be presented in forms of vectors. In this illustrative example, the embeddings from transformer decoders are fed into a number of prediction heads for predicting information associated with elements in the input image.

As depicted, prediction heads are software modules that map outputs from the transformer decoder to meaningful predictions that correspond to elements in the input image. For example, each object query is fed into a class head, a number of shape heads, and a color head for predicting categories of elements, shapes of elements, and color of elements. In this illustrative example, the prediction heads mentioned above can be examples of prediction heads 256 in FIG. 2.

In addition, all object queries are also passed into an adjacency layer and subsequently an adjacency head from the prediction heads. The adjacency head's job is to output an adjacency matrix A that is size N×N, where N is the number of nodes or elements in the input images. In this illustrative example, adjacency head can be a standard multi-layer perceptron (MLP) that for each input has a single output that corresponds to one entry in the N×N adjacency matrix. The adjacency layer is an additional layer of self-attention that helps architecture 500 to learn edges or relationships between elements more effectively.

In this illustrative example, the output from the prediction heads are numerical vectors that represent elements in the input image and relationships between the elements in the input image. The numerical vectors can be further processed to a machine readable format such as a table.

The illustration of architecture 500 in FIG. 5 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, the adjacency layer can be an optional layer for architecture 500 to extract information from visualizations.

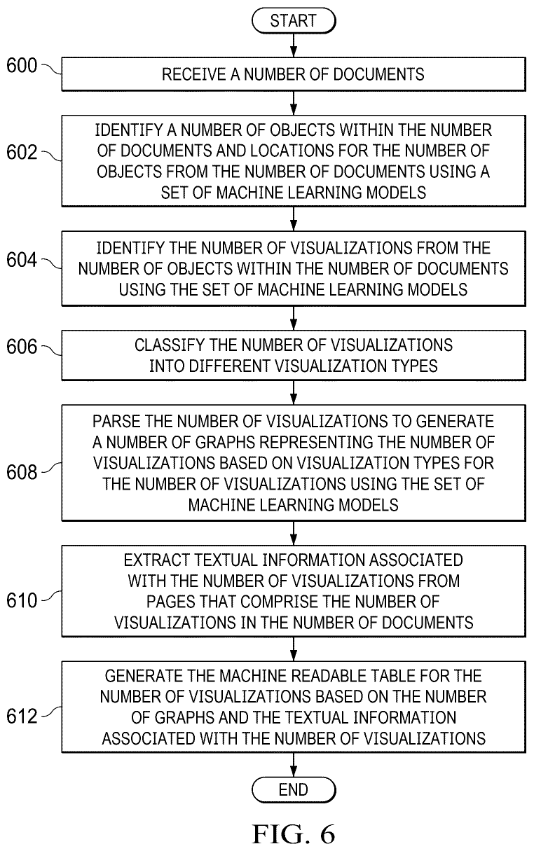

With reference now to FIG. 6, a flowchart illustrating a process for converting visualizations in documents to a machine readable table is shown in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in data manager 220 in computer system 204 in FIG. 2.

The process begins by receiving a number of documents (step 600). In step 600, the number of documents comprise a number of visualizations. The process identifies a number of objects within the number of documents and locations for the number of objects from the number of documents using a set of machine learning models (step 602).

The process identifies the number of visualizations from the number of objects within the number of documents using the set of machine learning models (step 604). The process classifies the number of visualizations into different visualization types (step 606). In step 606, each visualization from the number of visualizations is labeled with zero or more visualization types.

The process parses the number of visualizations to generate a number of graphs representing the number of visualizations based on visualization types for the number of visualizations using the set of machine learning models (step 608). The process extracts textual information associated with the number of visualizations from pages that comprise the number of visualizations in the number of documents (step 610).

The process generates the machine readable table for the number of visualizations based on the number of graphs and the textual information associated with the number of visualizations (step 612). The process terminates thereafter.

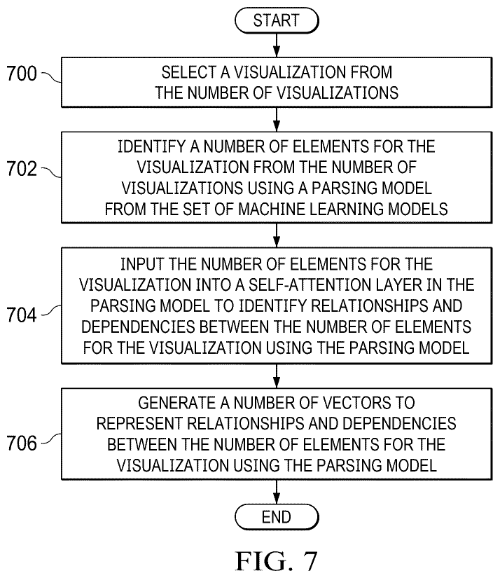

With reference now to FIG. 7, a flowchart illustrating a process for generating vectors to represent relationships and dependencies between elements in a visualization is shown in accordance with an illustrative embodiment. The process in this flowchart is an example of an implementation for step 608 in FIG. 6.

The process begins by selecting a visualization from the number of visualizations (step 700). The process identifies a number of elements for the visualization from the number of visualizations using a parsing model from the set of machine learning models (step 702). In step 702, the parsing model is selected based on visualization type for the visualization.

The process inputs the number of elements for the visualization into a self-attention layer in the parsing model to identify relationships and dependencies between the number of elements for the visualization using the parsing model (step 704). The process generates a number of vectors to represent relationships and dependencies between the number of elements for the visualization using the parsing model (step 706). The process terminates thereafter.

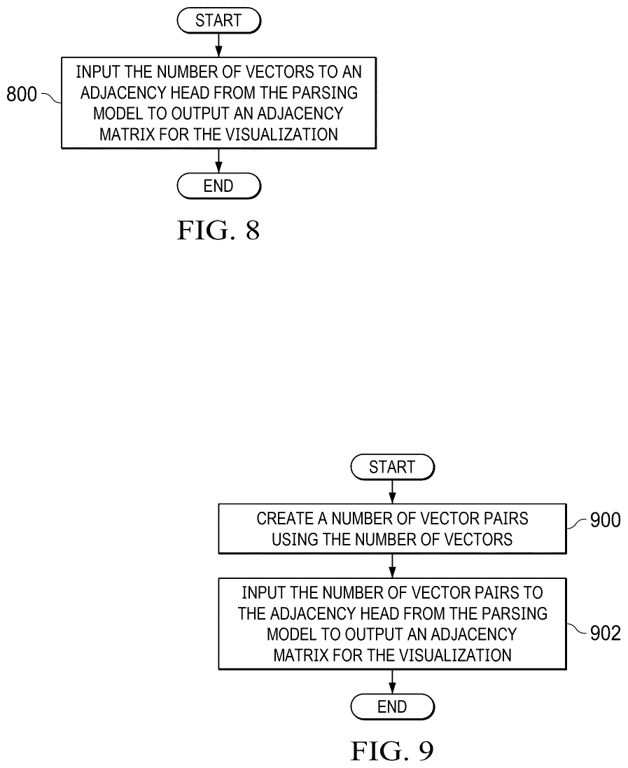

With reference now to FIG. 8, a flowchart illustrating a process for outputting an adjacency matrix is shown in accordance with an illustrative embodiment. The process in this figure is an example of an additional step that can be performed with the steps in FIG. 7.

The process begins by inputting the number of vectors to an adjacency head from the parsing model to output an adjacency matrix for the visualization (step 800). The process terminates thereafter.

With reference now to FIG. 9, a flowchart illustrating a process for outputting an adjacency matrix is shown in accordance with an illustrative embodiment. The process in this flowchart is an example of an implementation for step 800 in FIG. 8.

The process begins by creating a number of vector pairs using the number of vectors (step 900). In this step, each vector pairs from the number of vector pairs is created by concatenating two vectors from the number of vectors. The process inputs the number of vector pairs to the adjacency head from the parsing model to output an adjacency matrix for the visualization (step 902). The process terminates thereafter.

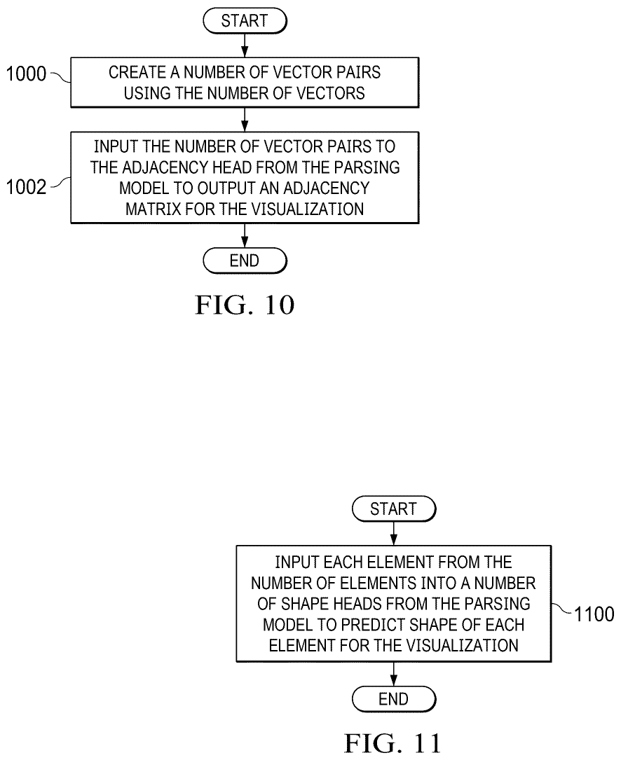

With reference now to FIG. 10, a flowchart illustrating a process for outputting an adjacency matrix is shown in accordance with an illustrative embodiment. The process in this flowchart is an example of an implementation for step 800 in FIG. 8.

The process begins by creating a number of vector pairs using the number of vectors (step 1000). In this step, each vector pairs from the number of vector pairs is created by summing two vectors from the number of vectors. The process inputs the number of vector pairs to the adjacency head from the parsing model to output an adjacency matrix for the visualization (step 1002). The process terminates thereafter.

With reference now to FIG. 11, a flowchart illustrating a process for predicting shape of elements in a visualization is shown in accordance with an illustrative embodiment. The process in this figure is an example of an additional step that can be performed with the steps in FIG. 7.

The process begins by inputting each element from the number of elements into a number of shape heads from the parsing model to predict shape of each element for the visualization (step 1100). In this step, each shape head from the number of shape heads is designed to predict a particular shape for the number of elements. The process terminates thereafter.

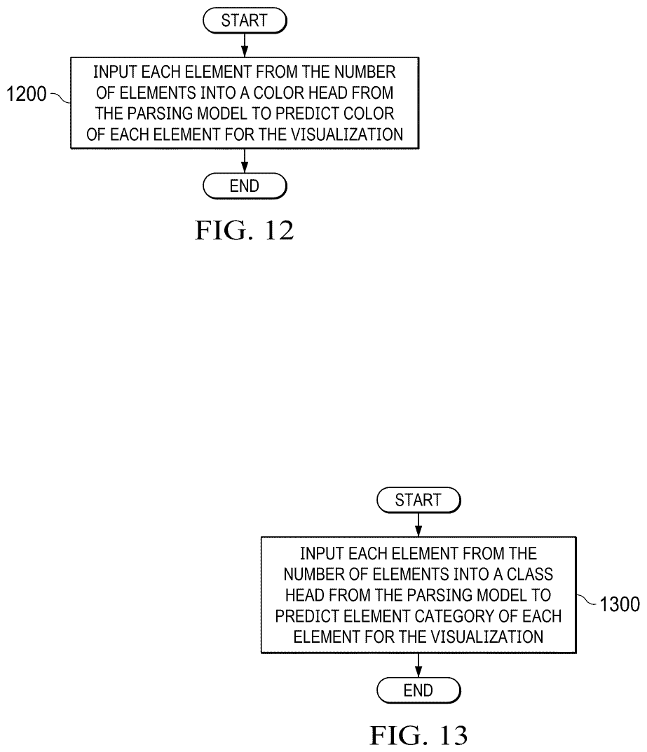

With reference now to FIG. 12, a flowchart illustrating a process for predicting color of elements in a visualization is shown in accordance with an illustrative embodiment. The process in this figure is an example of an additional step that can be performed with the steps in FIG. 7.

The process begins by inputting each element from the number of elements into a color head from the parsing model to predict color of each element for the visualization (step 1200). In this step, the color head predicts color values for each input element. The process terminates thereafter.

With reference now to FIG. 13, a flowchart illustrating a process for predicting categories of elements in a visualization is shown in accordance with an illustrative embodiment. The process in this figure is an example of an additional step that can be performed with the steps in FIG. 7.

The process begins by inputting each element from the number of elements into a class head from the parsing model to predict element category of each element for the visualization (step 1300). The process terminates thereafter.

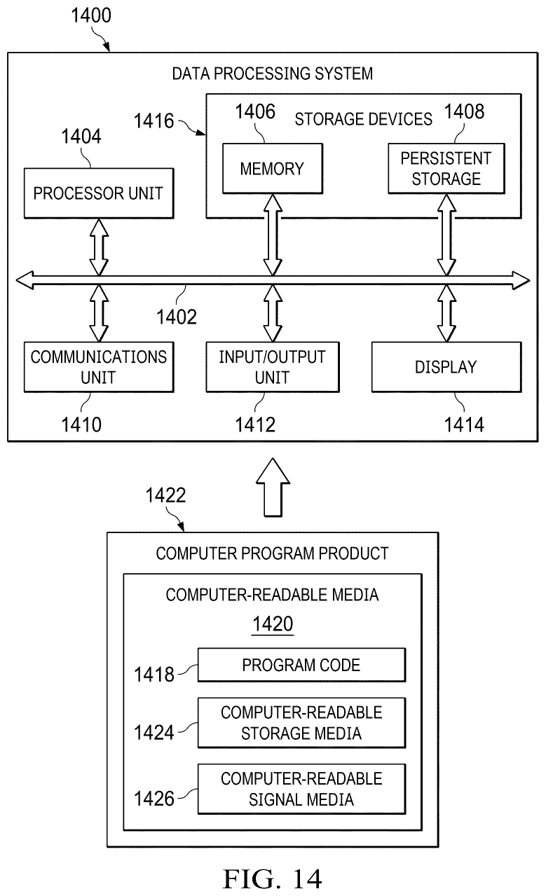

With reference now to FIG. 14, an illustration of a block diagram of a data processing system is depicted in accordance with an illustrative embodiment. Data processing system 1400 may be used to implement server computer 104 and server computer 106 and client devices 110 in FIG. 1, as well as computer system 204 in FIG. 2. In this illustrative example, data processing system 1400 includes communications framework 1402, which provides communications between processor unit 1404, memory 1406, persistent storage 1408, communications unit 1410, input/output unit 1412, and display 1414. In this example, communications framework 1402 may take the form of a bus system.

Processor unit 1404 serves to execute instructions for software that may be loaded into memory 1406. Processor unit 1404 may be a number of processors, a multi-processor core, or some other type of processor, depending on the particular implementation. In an embodiment, processor unit 1404 comprises one or more conventional general-purpose central processing units (CPUs). In an alternate embodiment, processor unit 1404 comprises one or more graphical processing units (GPUs).

Memory 1406 and persistent storage 1408 are examples of storage devices 1416. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1416 may also be referred to as computer-readable storage devices in these illustrative examples. Memory 1406, in these examples, may be, for example, a random access memory or any other suitable volatile or non-volatile storage device. Persistent storage 1408 may take various forms, depending on the particular implementation.

For example, persistent storage 1408 may contain one or more components or devices. For example, persistent storage 1408 may be a hard drive, a flash memory, a rewritable optical disk, a rewritable magnetic tape, or some combination of the above. The media used by persistent storage 1408 also may be removable. For example, a removable hard drive may be used for persistent storage 1408. Communications unit 1410, in these illustrative examples, provides for communications with other data processing systems or devices. In these illustrative examples, communications unit 1410 is a network interface card.

Input/output unit 1412 allows for input and output of data with other devices that may be connected to data processing system 1400. For example, input/output unit 1412 may provide a connection for user input through at least one of a keyboard, a mouse, or some other suitable input device. Further, input/output unit 1412 may send output to a printer. Display 1414 provides a mechanism to display information to a user.

Instructions for at least one of the operating system, applications, or programs may be located in storage devices 1416, which are in communication with processor unit 1404 through communications framework 1402. The processes of the different embodiments may be performed by processor unit 1404 using computer-implemented instructions, which may be located in a memory, such as memory 1406.

These instructions are referred to as program code, computer-usable program code, or computer-readable program code that may be read and executed by a processor in processor unit 1404. The program code in the different embodiments may be embodied on different physical or computer-readable storage media, such as memory 1406 or persistent storage 1408.

Program code 1418 is located in a functional form on computer-readable media 1420 that is selectively removable and may be loaded onto or transferred to data processing system 1400 for execution by processor unit 1404. Program code 1418 and computer-readable media 1420 form computer program product 1422 in these illustrative examples. In one example, computer-readable media 1420 may be computer-readable storage media 1424 or computer-readable signal media 1426.

In these illustrative examples, computer-readable storage media 1424 is a physical or tangible storage device used to store program code 1418 rather than a medium that propagates or transmits program code 1418. Computer-readable storage media 1424, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1418 may be transferred to data processing system 1400 using computer-readable signal media 1426. Computer-readable signal media 1426 may be, for example, a propagated data signal containing program code 1418. For example, computer-readable signal media 1426 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1400 are not meant to provide architectural limitations to the manner in which different embodiments may be implemented. The different illustrative embodiments may be implemented in a data processing system including components in addition to or in place of those illustrated for data processing system 1400. Other components shown in FIG. 14 can be varied from the illustrative examples shown. The different embodiments may be implemented using any hardware device or system capable of running program code 1418.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component with an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A computer-implemented method for converting visualizations in documents to a machine readable table, wherein the computer-implemented method comprises:
receiving, by a processor set, a number of documents, wherein the number of documents comprise a number of visualizations;
identifying, by the processor set using a set of machine learning models, a number of objects within the number of documents and locations for the number of objects from the number of documents;
identifying, by the processor set using the set of machine learning models, the number of visualizations from the number of objects within the number of documents;
classifying, by the processor set, the number of visualizations into different visualization types, wherein each visualization from the number of visualizations is labeled with zero or more visualization types;
parsing, by the processor set using the set of machine learning models, the number of visualizations to generate a number of graphs representing the number of visualizations based on visualization types for the number of visualizations, wherein parsing each visualization comprises applying image processing to detect visual elements and coordinates of the detected visual elements within the image of the visualization;
extracting, by the processor set, textual information associated with the number of visualizations from pages that contain the number of visualizations in the number of documents; and
generating, by the processor set, the machine readable table for the number of visualizations based on the number of graphs and the textual information associated with the number of visualizations.

2. The computer-implemented method of claim 1, wherein the number of graphs comprise a number of nodes representing elements in the number of visualizations and a number of edges between the number of nodes representing relationships between the elements in the number of visualizations and wherein the visualizations are images of charts, graphs, or diagrams embedded in unstructured documents.

3. The computer-implemented method of claim 1, wherein parsing, by the processor set using the set of machine learning models, the number of visualizations to generate a number of graphs representing the number of visualizations based on visualization types for the number of visualizations comprises:
selecting, by the processor set, a visualization from the number of visualizations;
identifying, by the processor set using a parsing model from the set of machine learning models, a number of elements for the visualization from the number of visualizations, wherein the parsing model is selected based on visualization type for the visualization;
inputting, by the processor set using the parsing model, the number of elements for the visualization into a self-attention layer in the parsing model to identify relationships and dependencies between the number of elements for the visualization; and
generating, by the processor set using the parsing model, a number of vectors to represent relationships and dependencies between the number of elements for the visualization.

4. The computer-implemented method of claim 3, further comprising:
inputting, by the processor set, the number of vectors to an adjacency head from the parsing model to output an adjacency matrix for the visualization, wherein the adjacency matrix is a representation of a graph for the visualization.

5. The computer-implemented method of claim 4, wherein the adjacency head is a standard multi-layer perceptron (MLP) for generating a number of outputs for each input, wherein the number of outputs generated for each input correspond to one full row of the adjacency matrix.

6. The computer-implemented method of claim 4, wherein inputting, by the processor set using the parsing model, the number of vectors to an adjacency head to output an adjacency matrix for the visualization comprises:
creating, by the processor set, a number of vector pairs using the number of vectors, wherein each vector pairs from the number of vector pairs is created by concatenating two vectors from the number of vectors; and
inputting, by the processor set, the number of vector pairs to the adjacency head from the parsing model to output an adjacency matrix for the visualization.

7. The computer-implemented method of claim 4, wherein inputting, by the processor set using the parsing model, the number of vectors to an adjacency head to output an adjacency matrix for the visualization comprises:
creating, by the processor set, a number of vector pairs using the number of vectors, wherein each vector pair from the number of vector pairs is created by summing two vectors from the number of vectors; and
inputting, by the processor set, the number of vector pairs to the adjacency head from the parsing model to output an adjacency matrix for the visualization.

8. The computer-implemented method of claim 3, further comprising:
inputting, by the processor set, each element from the number of elements into a number of shape heads from the parsing model to predict shape of each element for the visualization, wherein each shape head from the number of shape heads is designed to predict a particular shape for the number of elements.

9. The computer-implemented method of claim 3, further comprising:
inputting, by the processor set, each element from the number of elements into a color head from the parsing model to predict color of each element for the visualization, wherein the color head predicts color values for each input element.

10. The computer-implemented method of claim 3, further comprising:
inputting, by the processor set, each element from the number of elements into a class head from the parsing model to predict element category of each element for the visualization.

11. The computer-implemented method of claim 1, wherein the set of machine learning models comprise a number of parsing models, and wherein each parsing model from the number of parsing models is designed to perform parsing for visualizations of a particular visualization type.

12. A computer system for converting visualizations in documents to a machine readable table, comprising:
a processor set;
a set of one or more computer-readable storage media; and
program instructions stored on the set of one or more computer-readable storage media to cause the processor set to perform operations comprising:
receiving a number of documents, wherein the number of documents comprise a number of visualizations;
identifying a number of objects within the number of documents and locations for the number of objects from the number of documents using a set of machine learning models;
identifying the number of visualizations from the number of objects within the number of documents using the set of machine learning models;
classifying the number of visualizations into different visualization types, wherein each visualization from the number of visualizations is labeled with zero or more visualization types;
parsing the number of visualizations to generate a number of graphs representing the number of visualizations based on visualization types for the number of visualizations using the set of machine learning models, wherein parsing each visualization comprises applying image processing to detect visual elements and coordinates of the detected visual elements within the image of the visualization;
extracting textual information associated with the number of visualizations from pages that contain the number of visualizations in the number of documents; and
generating the machine readable table for the number of visualizations based on the number of graphs and the textual information associated with the number of visualizations.

13. The computer system of claim 12, wherein the number of graphs comprise a number of nodes representing elements in the number of visualizations and a number of edges between the number of nodes representing relationships between elements in the number of visualizations and wherein the visualizations are images of charts, graphs, or diagrams embedded in unstructured documents.

14. The computer system of claim 12, wherein parsing the number of visualizations to generate a number of graphs representing the number of visualizations based on visualization types for the number of visualizations using the set of machine learning models comprises:
selecting a visualization from the number of visualizations;
identifying a number of elements for the visualization from the number of visualizations using a parsing model from the set of machine learning models, wherein the parsing model is selected based on visualization type for the visualization;
inputting the number of elements for the visualization into a self-attention layer in the parsing model to identify relationships and dependencies between the number of elements for the visualization using the parsing model; and
generating a number of vectors to represent relationships and dependencies between the number of elements for the visualization using the parsing model.

15. The computer system of claim 14, wherein the operations further comprise:
inputting the number of vectors to an adjacency head from the parsing model to output an adjacency matrix for the visualization, wherein the adjacency matrix is a representation of a graph for the visualization.

16. The computer system of claim 15, wherein the adjacency head is a standard multi-layer perceptron (MLP) for generating a number of outputs for each input, wherein the number of outputs generated for each input correspond to one full row of the adjacency matrix.

17. The computer system of claim 15, wherein inputting the number of vectors to an adjacency head to output an adjacency matrix for the visualization using the parsing model comprises:
creating a number of vector pairs using the number of vectors, wherein each vector pairs from the number of vector pairs is created by concatenating two vectors from the number of vectors; and
inputting the number of vector pairs to the adjacency head from the parsing model to output an adjacency matrix for the visualization.

18. The computer system of claim 15, wherein inputting the number of vectors to an adjacency head to output an adjacency matrix for the visualization using the parsing model comprises:
creating a number of vector pairs using the number of vectors, wherein each vector pair from the number of vector pairs is created by summing two vectors from the number of vectors; and
inputting the number of vector pairs to the adjacency head from the parsing model to output an adjacency matrix for the visualization.

19. The computer system of claim 14, wherein the operations further comprise:
inputting each element from the number of elements into a number of shape heads from the parsing model to predict shape of each element for the visualization, wherein each shape head from the number of shape heads is designed to predict a particular shape for the number of elements.

20. The computer system of claim 14, wherein the operations further comprise:
inputting each element from the number of elements into a color head from the parsing model to predict color of each element for the visualization, wherein the color head predicts color values for each input element.

21. The computer system of claim 14, wherein the operations further comprise: inputting each element from the number of elements into a class head from the parsing model to predict element category of each element for the visualization.

22. The computer system of claim 12, wherein the set of machine learning models comprise a number of parsing models, and wherein each parsing model from the number of parsing models is designed to perform parsing for visualizations of a particular visualization type.

23. A computer program product for converting visualizations in documents to a machine readable table, comprising:
a set of one or more computer-readable storage media;
program instructions stored in the set of one or more computer-readable storage media to perform operations comprising:
receiving, by a processor set, a number of documents, wherein the number of documents comprise a number of visualizations;
identifying, by the processor set using a set of machine learning models, a number of objects within the number of documents and locations for the number of objects from the number of documents;
identifying, by the processor set using the set of machine learning models, the number of visualizations from the number of objects within the number of documents;
classifying, by the processor set, the number of visualizations into different visualization types, wherein each visualization from the number of visualizations is labeled with zero or more visualization types;
parsing, by the processor set using the set of machine learning models, the number of visualizations to generate a number of graphs representing the number of visualizations based on visualization types for the number of visualizations, wherein parsing each visualization comprises applying image processing to detect visual elements and coordinates of the detected visual elements within the image of the visualization;
extracting, by the processor set, textual information associated with the number of visualizations from pages that contain the number of visualizations in the number of documents; and
generating, by the processor set, the machine readable table for the number of visualizations based on the number of graphs and the textual information associated with the number of visualizations.

24. The computer program product of claim 23, wherein the number of graphs comprise a number of nodes representing elements in the number of visualizations and a number of edges between the number of nodes representing relationships between elements in the number of visualizations and wherein the visualizations are images of charts, graphs, or diagrams embedded in unstructured documents.

25. The computer program product of claim 23, wherein parsing, by the processor set using the set of machine learning models, the number of visualizations to generate a number of graphs representing the number of visualizations based on visualization types for the number of visualizations comprises:
selecting, by the processor set, a visualization from the number of visualizations;
identifying, by the processor set using a parsing model from the set of machine learning models, a number of elements for the visualization from the number of visualizations, wherein the parsing model is selected based on visualization type for the visualization;
inputting, by the processor set using the parsing model, the number of elements for the visualization into a self-attention layer in the parsing model to identify relationships and dependencies between the number of elements for the visualization; and
generating, by the processor set using the parsing model, a number of vectors to represent relationships and dependencies between the number of elements for the visualization.

26. The computer program product of claim 25, wherein the operations further comprise:
inputting, by the processor set, the number of vectors to an adjacency head from the parsing model to output an adjacency matrix for the visualization, wherein the adjacency matrix is a representation of a graph for the visualization.

27. The computer program product of claim 26, wherein the adjacency head is a standard multi-layer perceptron (MLP) for generating a number of outputs for each input, wherein the number of outputs generated for each input correspond to one full row of the adjacency matrix.

28. The computer program product of claim 26, wherein inputting, by the processor set using the parsing model, the number of vectors to an adjacency head to output an adjacency matrix for the visualization comprises:
creating, by the processor set, a number of vector pairs using the number of vectors, wherein each vector pairs from the number of vector pairs is created by concatenating two vectors from the number of vectors; and
inputting, by the processor set, the number of vector pairs to the adjacency head from the parsing model to output an adjacency matrix for the visualization.

29. The computer program product of claim 26, wherein inputting, by the processor set using the parsing model, the number of vectors to an adjacency head to output an adjacency matrix for the visualization comprises:
creating, by the processor set, a number of vector pairs using the number of vectors, wherein each vector pair from the number of vector pairs is created by summing two vectors from the number of vectors; and
inputting, by the processor set, the number of vector pairs to the adjacency head from the parsing model to output an adjacency matrix for the visualization.

30. The computer program product of claim 25, wherein the operations further comprise:
inputting, by the processor set, each element from the number of elements into a number of shape heads from the parsing model to predict shape of each element for the visualization, wherein each shape head from the number of shape heads is designed to predict a particular shape for the number of elements.

31. The computer program product of claim 25, wherein the operations further comprise:
inputting, by the processor set, each element from the number of elements into a color head from the parsing model to predict color of each element for the visualization, wherein the color head predicts color values for each input element.

32. The computer program product of claim 25, wherein the operations further comprise:
inputting, by the processor set, each element from the number of elements into a class head from the parsing model to predict element category of each element for the visualization.

33. The computer program product of claim 23, wherein the set of machine learning models comprise a number of parsing models, and wherein each parsing model from the number of parsing models is designed to perform parsing for visualizations of a particular visualization type.
